(19) United States
(12) Patent Application Publication
(10) Pub. No.: US 2010/0083244 A1
(43) Pub. Date: Apr. 1, 2010

(54) METHODS, APPARATUSES, AND COMPUTER PROGRAM PRODUCTS FOR REPURPOSING COMPUTING DEVICES

(75) Inventors: Les Bothwell, Alton (GB); Nick Filler, Godalming (GB); Stavros Kyris, London (GB); Daniel O'Connell, Alton (GB); Mikko Tamminen, Coventry (GB)

Correspondence Address: DITTHAVONG MORI & STEINER, P.C., 918 Prince Street, Alexandria, VA, 22314, US

(73) Assignee: Nokia Corporation

(21) Appl. No.: 12/238,979

(22) Filed: Sep. 26, 2008

(51) Int. Cl. G06F 9/445; G06F 15/16; G06F 12/16; G06F 17/30

(52) U.S. Cl. 717/174; 717/178

(57) ABSTRACT

An apparatus may include a processor configured to analyze a connected device to determine one or more capabilities of the device. The processor may be further configured to suggest one or more applications that the device is capable of implementing based at least in part upon the determined capabilities. The processor may be additionally configured to program at least one suggested application into a memory of the device such that the device is repurposed. Corresponding methods and computer program products are also provided.

### TECHNOLOGICAL FIELD

Embodiments of the present invention relate generally to mobile communication technology and, more particularly, relate to methods, apparatuses, and computer program products for repurposing computing devices.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to further improve the convenience to users is the repurposing of computing devices, and in particular mobile computing devices using wireless and mobile networking technologies. In the past few years, there have been several advancements in mobile device technology that are quickly rendering mobile devices in the market obsolete. Many new mobile device models are being developed or are currently on the market that combine features previously found only in separate, more limited purpose devices into a single multipurpose device. For example, features of cellular phones, personal digital assistants (PDAs), and digital media players are being integrated into a single mobile device. Further, many mobile devices now include features that allow a user to browse the Internet, send email, take pictures, play games, etc. These new features are highly desirable to users and many older mobile devices currently in use or which were previously used are being replaced by this next generation of mobile devices. In fact, the rapid pace of improvement in mobile device technology has resulted in many users upgrading or otherwise replacing their mobile devices with a next generation device in as little as every 9 to 18 months.

This frequent replacement of mobile devices and the ubiquity of usage of mobile devices has resulted in significant numbers of outdated or otherwise unused mobile devices. Some of these outdated mobile devices may be donated to users of lesser means for use as cell phones or for other purposes or may be recycled such that the plastics and metals comprising the mobile device may be reused. However, the vast majority of older mobile devices either remain stored away unused by their owners or are disposed of in landfills. Disposal of mobile devices in landfills is of particular environmental concern both due to the increased volume of waste for disposal in landfills as well as materials used in construction of mobile devices that may pose environmental problems if not properly disposed of.

Owners of mobile devices that are no longer used for their initial purpose might still use their older mobile devices if they were repurposed for a use other than their initial purpose. In this regard, a mobile device that was initially used by a consumer as, for example, a cellular telephone, may have computing resources and/or specialized hardware to facilitate use of the mobile device for another primary purpose of use to a consumer. If the mobile device could be repurposed for such another primary purpose, then consumers may continue using their older mobile devices rather than storing them away unused or throwing them away. Accordingly, it may be advantageous to provide computing device users with methods, apparatuses, and computer program products for repurposing computing devices.

### BRIEF SUMMARY OF SOME EXAMPLES OF THE INVENTION

A method, apparatus, and computer program product are therefore provided, which may provide for repurposing computer devices. In particular, a method, apparatus, and computer program product may be provided to enable, for example, analysis of a computing device, such as a cellular communications device, to determine capabilities of the computing device. The capabilities may comprise computing resources of the computing device as well as hardware components embodied in the mobile device and the operability thereof. Embodiments of the invention further provide for suggesting one or more applications that the device is capable of implementing based at least in part upon the determined capabilities. A user may then select one or more of the suggested applications to install on the device. At least one suggested application may then be programmed into a memory of the device such that the device is repurposed based at least in part upon the user selection.

In one exemplary embodiment, a method is provided which may include analyzing a connected device to determine one or more capabilities of the device. The method may further include suggesting one or more applications that the device is capable of implementing based at least in part upon the determined capabilities. The method may also include programming at least one suggested application into a memory of the device such that the device is repurposed.

In another exemplary embodiment, a computer program product is provided. The computer program product includes at least one computer-readable storage medium having computer-readable program instructions stored therein. The computer-readable program instructions may include first, second, and third program instructions. The first program instruction is for analyzing a connected device to determine one or more capabilities of the device. The second program instruction is for suggesting one or more applications that the device is capable of implementing based at least in part upon the determined capabilities. The third program instruction is for programming at least one suggested application into a memory of the device such that the device is repurposed.

In another exemplary embodiment, an apparatus is provided, which may include a processor. The processor may be configured to analyze a connected device to determine one or more capabilities of the device. The processor may further be configured to suggest one or more applications that the device is capable of implementing based at least in part upon the determined capabilities. The processor may additionally be configured to program at least one suggested application into a memory of the device such that the device is repurposed.

In another exemplary embodiment, an apparatus is provided that may include means for analyzing a connected device to determine one or more capabilities of the device. The apparatus may further include means for suggesting one or more applications that the device is capable of implementing based at least in part upon the determined capabilities. The apparatus may additionally include means for programming at least one suggested application into a memory of the device such that the device is repurposed.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of a system for repurposing computing devices;

FIG. 2 is a schematic block diagram of a mobile terminal according to an exemplary embodiment of the present invention;

FIG. 3 illustrates a screenshot of a user interface for suggesting and selecting applications that may be implemented on a computing device according to an exemplary embodiment of the present invention;

FIG. 4 illustrates a block diagram of a system for providing a plurality of services, including device repurposing, to computing devices according to an exemplary embodiment of the present invention;

FIG. 5 is a flowchart according to an exemplary method for repurposing computing devices according to an exemplary embodiment of the present invention; and

FIG. 6 is a flowchart according to an exemplary method for repurposing computing devices over a system for providing a plurality of services, including device repurposing, to computing devices according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

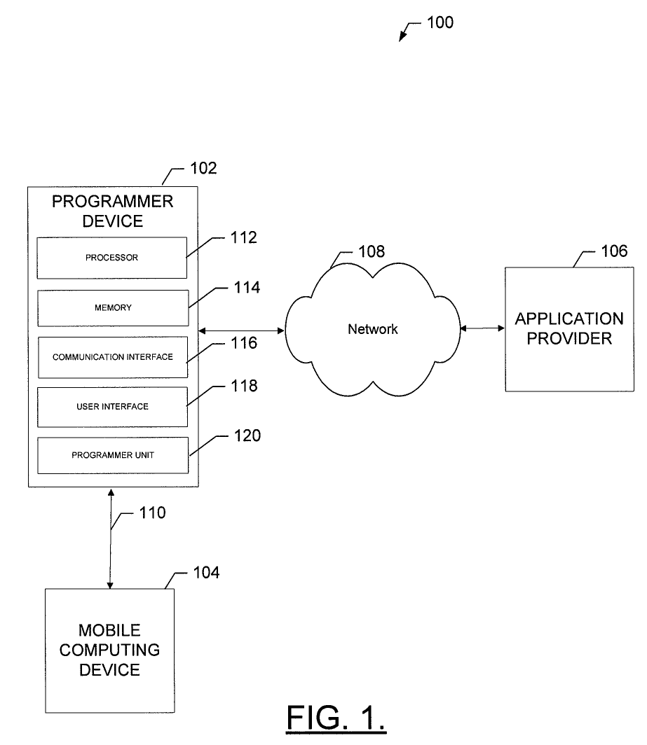

FIG. 1 illustrates a block diagram of a system 100 for repurposing computing devices according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for repurposing computing devices, numerous other configurations may also be used to implement embodiments of the present invention.

As used herein, “repurposing” refers to reconfiguring a computing device, such as, for example, a mobile cellular telephone device, for a use other than its original primary intended use. In this regard, the repurposing may comprise installing and/or removing software and/or firmware modules comprising program instructions that harness computing resources and hardware components available on the computing device for a purpose other than the original primary intended use. Such a “purpose” may include, for example, use as a radio, short range communications device, illumination device, clock, alarm clock, gaming device, language translation device, electronic dictionary device, personal digital assistant, data storage device, personal navigation device, digital camera, and/or media player.

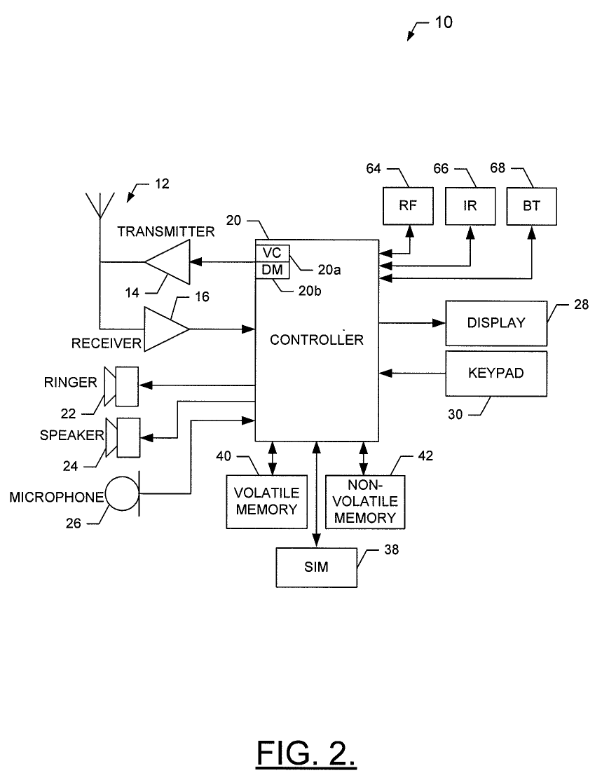

Referring now to FIG. 1, the system 100 may include a programmer device 102, mobile computing device 104, and application provider 106. The programmer device 102 and application provider 106 may be configured to communicate over the network 108. The programmer device 102 and mobile computing device 104 may be configured to be connectable and communicate via a communications link 110. Although referred to herein for purposes of example as a “mobile” computing device 104, it will be appreciated that embodiments of the present invention are not limited to repurposing of mobile computing devices and indeed other computing devices, such as personal computers, may be repurposed in accordance with embodiments of the invention. One example of a mobile computing device 104 is depicted in FIG. 2.

In this regard, FIG. 2 illustrates a block diagram of a mobile terminal 10 representative of one embodiment of a mobile computing device 104 in accordance with embodiments of the present invention. It should be understood, however, that the mobile terminal illustrated and hereinafter described is merely illustrative of one type of mobile computing device 104 that may benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a controller 20 or other processor(s) that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless local access network (WLAN) techniques such as Institute of Electrical and Electronics Engineers (IEEE) 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise circuitry for implementing audio/video and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the controller 20. As used herein, “operationally coupled” may include any number or combination of intervening elements (including no intervening elements) such that operationally coupled connections may be direct or indirect and in some instances may merely encompass a functional relationship between components. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to ultra-low power Bluetooth technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, the programmer device 102 may be embodied as any computing device, mobile or fixed, and may be embodied as a server, desktop computer, laptop computer, mobile terminal 10, and/or the like. The programmer device 102 may also be embodied as a combination of a plurality of computing devices configured to communicate with an application provider 106 over a network 108 as well as with a mobile computing device 104 over a communications link 110. In this regard, the programmer device 102 may be embodied, for example, as a server cluster and/or may be embodied as a distributed computing system, such as may be distributed across a plurality of computing devices. The application provider 106 may be embodied as any computing device or plurality of computing devices configured to provide software and/or firmware applications to a requesting programmer device 102 as will be described further herein below. An “application” as used herein may comprise any computer program instruction or unit thereof, including, but not limited to, software applications, firmware applications, device drivers, and/or the like. The application provider 106 may be embodied as a server in an exemplary embodiment. Further, although only a single application provider 106 is illustrated in FIG. 1, the system 100 may comprise a plurality of application providers 106.

The network 108 may be any network over which the programmer device 102 and application provider 106 are configured to communicate. Accordingly, the network 108 may be a wireless network, a wireline network, or any combination thereof, and in some embodiments may comprise the internet. The network 108 may be a structured or an ad hoc network. The network 108 may further utilize any communications protocol or combination of communications protocols that may facilitate inter-device communication between the programmer device 102 and application provider 106.

The communications link 110 may comprise any temporary communications link by which the programmer device 102 and mobile computing device 104 may be connected and communicate with each other. In this regard, the communications link 110 may comprise a wired communications link, wireless communications link, or some combination thereof. In some embodiments, the communications link 110 may comprise an indirect connection via a network, such as the internet, rather than a direct physical wired or dedicated wireless connection between the programmer device 102 and mobile computing device 104. Examples of wired communications link embodiments of the communications link 110 include, but are not limited to, a Universal Serial Bus (USB) cable, Firewire (Institute of Electrical and Electronics Engineers (IEEE) 1394) cable, parallel cable (IEEE 1284), serial cable (IEEE 1384), small computer system interface (SCSI), and/or the like. Examples of wireless communications link embodiments of the communications link 110 include, but are not limited to, a Bluetooth connection, wireless local area network (WLAN) connection, such as in accordance with one of the 802.11 standards, other radio frequency communications interface standards, infrared (IR), wireless USB, and/or the like.

The programmer device 102 may include various means, such as a processor 112, memory 114, communication interface 116, user interface 118, and programmer unit 120 for performing the various functions herein described. These means of the programmer device 102 as described herein may be embodied as, for example, hardware elements (e.g., a suitably programmed processor, combinational logic circuit, and/or the like), computer code (e.g., software or firmware) embodied on a computer-readable medium (e.g. memory 114) that is executable by a suitably configured processing device, or some combination thereof. The processor 112 may, for example, be embodied as various means including a microprocessor, a coprocessor, a controller, or various other processing elements including integrated circuits such as, for example, an ASIC (application specific integrated circuit) or FPGA (field programmable gate array). In an exemplary embodiment, the processor 112 may be configured to execute instructions stored in the memory 114 or otherwise accessible to the processor 112. Although illustrated in FIG. 1 as a single processor, the processor 112 may comprise a plurality of processors operating in parallel, such as a multi-processor system.

The memory 114 may include, for example, volatile and/or non-volatile memory. The memory 114 may be configured to store information, data, applications, instructions, or the like for enabling the programmer device 102 to carry out various functions in accordance with exemplary embodiments of the present invention. For example, the memory 114 may be configured to buffer input data for processing by the processor 112. Additionally or alternatively, the memory 114 may be configured to store instructions for execution by the processor 112. The memory 114 may comprise one or more databases that store information in the form of static and/or dynamic information. In this regard, the memory 114 may store, for example, applications downloaded from an application provider 106 for installation on a mobile computing device 104, profile information comprising information about capabilities of a mobile computing device 104 and/or information about applications installed on a mobile computing device 104, and/or backed up data copied from a mobile computing device 104. This stored information may be stored and/or used by the programmer unit 120 during the course of performing its functionalities.

The communication interface 116 may be embodied as any device or means embodied in hardware, software, firmware, or a combination thereof that is configured to receive and/or transmit data from/to a network and/or any other device or module in communication with the programmer device 102. In one embodiment, the communication interface 116 may be at least partially embodied as or otherwise controlled by the processor 112. In this regard, the communication interface 116 may include, for example, an antenna, a transmitter, a receiver, a transceiver and/or supporting hardware or software for enabling communications with other entities of the system 100, such as an application provider 106 via the network 108 and a mobile computing device 104 via a communications link 110. The communication interface 116 may be configured to receive and/or transmit data using any protocol that may be used for communications between the programmer device 102 and application provider 106 over the network 108 as well as between the programmer device 102 and mobile computing device 104 over the communications link 110. The communication interface 116 may additionally be in communication with the memory 114, user interface 118, and/or programmer unit 120.

The user interface 118 may be in communication with the processor 112 to receive an indication of a user input and/or to provide an audible, visual, mechanical, or other output to the user. As such, the user interface 118 may include, for example, a keyboard, a mouse, a joystick, a display, a touch screen display, a microphone, a speaker, and/or other input/output mechanisms. Accordingly, the user interface 118 may facilitate providing a user of a programmer device 102 with an indication of capabilities of a mobile computing device 104, suggested applications for programming into a mobile computing device 104, as well as other information related to repurposing a mobile computing device 104. The user interface 118 may additionally be configured to receive from a user of a programmer device 102 commands and/or queries related to repurposing of a mobile computing device 104. In this regard, the user interface 118 may further be in communication with the memory 114 and/or programmer unit 120.

The programmer unit 120 may be embodied as various means, such as hardware, software, firmware, or some combination thereof and, in one embodiment, may be embodied as or otherwise controlled by the processor 112. In embodiments where the programmer unit 120 is embodied separately from the processor 112, the programmer unit 120 may be in communication with the processor 112. In an exemplary embodiment, the programmer unit 120 may be embodied as a software module installed on the programmer device 102. In this regard, the programmer unit 120 may be downloaded from a remote computing entity, such as, for example, the application provider 106 over the network 108. Such a remote computing entity may be maintained by a mobile computing device manufacturer, which may distribute the programmer module and/or applications for installation on a mobile computing device 104. Additionally or alternatively, the programmer unit 120 may be installed on the programmer device 102 from a physical medium, such as a compact disc read-only memory (CD-ROM) or digital versatile disc read-only memory (DVD-ROM). Further, although pictured in FIG. 1 and described herein for purposes of example as embodied on the programmer device 102, in an alternative embodiment, the programmer unit 120 may be embodied as a server-side program remotely executed by a remote computing entity, such as the application provider 106. In this regard, the processor 112 or other element of the programmer device 102 may be configured to access the remotely executed programmer unit 120 over the network 108 using the communication interface 116. A user of the programmer device 102 may then be able to interact with the programmer unit 120 through elements of a graphical user interface of the programmer unit 120 that may be displayed on a display connected to the programmer device 102.

The programmer unit 120 may be configured to provide means for analyzing a connected mobile computing device 104 to determine one or more capabilities of the mobile computing device 104. In this regard, the programmer unit 120 may be configured to determine a manufacturer and/or model of the mobile computing device 104. The programmer unit 120 may further be configured to determine computing and hardware resources available on the mobile computing device 104. These computing and hardware resources may comprise, for example, a type of processing element embodied on the mobile computing device 104, architecture of the mobile computing device 104, memory space (such as may be embodied in volatile memory 40 and/or non-volatile memory 42 of a mobile terminal 10) available on the mobile computing device 104, hardware components embodied on the mobile computing device 104, and/or the like. Example hardware components that may be determined to be embodied on a mobile computing device 104 include, for example, camera module, global positioning system (GPS) module, various communications elements (e.g., RF module 64, IR module 66, BT module 68, cellular transceiver, WLAN and/or the like), display, keypad, keyboard, speaker, microphone, and/or the like. The programmer unit may further be configured to determine software and/or firmware components installed on the mobile computing device 104. Examples of such software and firmware components include operating systems, applications, drivers, data stored in a memory of the mobile computing device 104, and/or the like. The programmer unit 120 may additionally be configured to determine the operability of the determined hardware, software, and/or firmware components. In this regard, the programmer unit 120 may be configured to determine whether the components are currently operable and if not currently operable whether they can be fixed, such as through software debugging or reinstallation of software, firmware, and/or drivers. In an exemplary embodiment, the programmer unit 120 may additionally be configured to analyze a battery component of the mobile computing device 104 to determine the viability of the battery component and whether the battery should be replaced.

The programmer unit 120 may further be configured to provide means for suggesting one or more applications that the mobile computing device 104 is capable of implementing so as to repurpose the mobile computing device 104. The suggestion may be based at least in part upon the determined capabilities of the mobile computing device 104. In this regard, the suggested applications may be suggested by the programmer unit 120 based upon computing resources required for each respective application compared to computing resources available on the mobile computing device 104. The required computing resources may be defined, for example, by a developer of each respective application and may be known by the programmer unit 120 or may be accessible by the programmer unit 120 from a remote location, such as the application provider 106. For applications that have multiple versions, such as may be tailored based upon device computing resources, the programmer unit 120 may further be configured to suggest an appropriate version that is capable of being implemented on the mobile computing device 104. In another example, the programmer unit 120 may be configured to determine whether a language-dependent application may be programmed into a memory of the mobile computing device 104 based upon the determined capabilities. In this regard, an electronic dictionary may only function if the mobile computing device 104 includes a keypad or keyboard tailored for use in a particular region. The programmer unit 120 may accordingly only suggest applications, such as electronic dictionaries, that the mobile computing device 104 is fully capable of implementing based upon the determined capabilities.

As an example, the memory 114 may store various applications and/or references thereto that may be programmed into a mobile computing device 104. Each application or reference to an application may be stored in association with corresponding capabilities of a mobile computing device 104 that are required or at least highly suggested for a computing device 104 to be capable of implementing the application. Accordingly, the programmer unit 120 may be configured to search or otherwise query the stored applications or references thereto and the corresponding required capabilities based at least in part upon the determined capabilities of the mobile computing device 104 to determine applications having computing capabilities requirements that do not exceed the determined capabilities of the mobile computing device 104. The programmer unit 120 may then suggest the determined applications having computing capabilities requirements that do not exceed the determined capabilities of the mobile computing device 104.

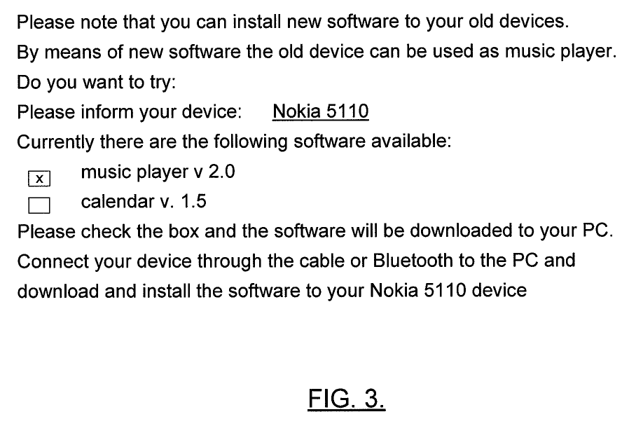

The programmer unit 120 may present the one or more suggested applications to a user of the programmer device 102 over the user interface 118. In this regard, FIG. 3 illustrates a screenshot of a user interface for suggesting and selecting applications that may be implemented on a computing device according to an exemplary embodiment of the present invention. If one or more components of the mobile computing device 104 are inoperable such that the device 104 is incapable of implementing any application and thus cannot be repurposed, the programmer unit 120 may be configured to provide information about recycling the mobile computing device 104 to a user of the programmer device 102. This information may comprise, for example, information about safe device disposal practices and recycling/collection centers near the user's current location. The programmer device 102 may further be configured to receive an indication of a selection of one or more suggested applications. This selection may be indicated by the user via the user interface 118. Referring again to FIG. 3, for example, a user may be presented with a selection box for each suggested application such that the user may mark one or more suggested applications for implementation on the mobile computing device 104. In FIG. 3, a user has selected to implement the “music player v 2.0” application.

The programmer unit 120 may additionally be configured to provide means for programming one or more suggested applications into a memory of the mobile computing device 104 such that the device 104 is repurposed. The suggested applications programmed into a memory of the mobile computing device 104 by the programmer unit 120 may be based upon the received indication of a user selection of one or more suggested applications. In an exemplary embodiment, the programmer unit 120 may first download applications to be programmed into a memory of the mobile computing device 104 to the programmer device 102. The programmer unit 120 may download the applications from an application provider 106 and store the downloaded applications at least temporarily in memory 114 prior to programming the applications into the mobile computing device 104.

It will be appreciated that the programmer unit 120 may be configured to program applications into a memory of the mobile computing device 104 by any of several means. In this regard, the programmer unit 120 may program an application into a non-volatile memory (e.g., a volatile memory 40, hard drive, flash memory, electrically erasable programmable read-only memory (EEPROM), and/or the like) or even a volatile memory (e.g. non-volatile memory 42, random access memory, and/or the like) of the mobile computing device 104. The programmer unit 120 may be configured to simply program an application into a memory of the mobile computing device 104 without removing or modifying any applications or functionalities already installed on the mobile computing device 104. Additionally or alternatively, the programmer unit 120 may be configured to selectively remove certain software and/or firmware components from memory of the mobile computing device 104 prior to programming any applications into a memory of the mobile computing device 104. In this regard, the programmer unit 120 may be configured to determine components to selectively remove from memory of the mobile computing device 104 based upon a stored listing of components that should be removed from a mobile computing device 104 if present on the mobile computing device 104. This listing of components may be stored, for example, in memory 114 and may be global for all mobile computing devices 104, unique based upon a model of the mobile computing device 104, and/or unique based upon an application selected to be programmed into a memory of the mobile computing device 104 (e.g. based upon a compatibility issue or computing resource requirement of the application). Accordingly, if the programmer unit 120 determines that any components currently implemented in a memory of the mobile computing device 104 are referenced on one or more listings of components for removal, the programmer unit 120 may be configured to remove the one or more listed components from memory of the mobile computing device 104. Further, the programmer unit 120 may be configured to erase the memory of the mobile computing device and re-flash the memory with at least one application. In this regard, the programmer unit 120 may be configured to remove one or more components from memory of the mobile computing device 104 and/or disable a functionality(ies) or hardware component(s) of the mobile computing device 104. Removing and/or disabling components from the mobile computing device 104 may serve to free up computing resources that may otherwise be wasted and thus serve to make the mobile computing device 104 more effective at implementing the newly programmed application(s) following repurposing of the device 104. Accordingly, the programmer unit 120 may be configured to determine what, if any, components should be selectively removed and/or disabled so as to optimize the repurposed mobile computing device 104 based upon the application(s) to be programmed into a memory of the device 104. Further, removing and/or disabling components from the mobile computing device 104 may prevent access to functionalities that the user does not want to be accessible following repurposing. In this regard, a user may provide an indication to the programmer unit 120 identifying one or more components to be removed or disabled. For example, in embodiments wherein the mobile computing device 104 is configured for operation as a cellular telephone prior to repurposing, a user may wish for the cellular phone communications functionality to be disabled so as to avoid the possibility of being billed for unwanted phone calls sent/received by the device if the mobile computing device 104 is to be repurposed, for example, as a gaming device to be given to a child.

In an exemplary embodiment, the programmer unit 120 may be configured to back up data stored in memory of the mobile computing device 104 and/or a state of the mobile computing device 104 prior to programming any application into mobile computing device 104 memory and repurposing the device 104. The backed up data and state may be stored in the memory 114 of the programmer device 102 or may be stored remotely in memory of another computing device, such as in a memory of the application provider 106. The backed up data may comprise, for example, a user's contacts list, text messages, phone call history, personal schedule, photos, media clips, and/or other data stored in a memory of the mobile computing device 104. The programmer unit 120 may be configured to selectively backup certain data selected by a user to be saved from the mobile computing device 104 prior to repurposing. The backed up data can then be retrieved by the user and either accessed or transferred to another computing device. The backed up state of the mobile computing device 104 may comprise information about the software and hardware configuration of the mobile computing device 104 prior to repurposing. The backed up state may be saved for future use in case the user later wants to restore the mobile computing device 104 to a prior state. Accordingly, the programmer unit 120 may be configured to restore a repurposed mobile computing device 104 to a prior state based at least in part upon the backed up data and/or a backed up state of the device. When restoring a mobile computing device 104 to a previous state, the previously installed software, firmware, drivers, and/or the like may be reprogrammed into a memory of the mobile computing device 104 and any applications programmed into the mobile computing device 104 for repurposing the device 104 may be removed. In one embodiment, the programmer unit 120 may be configured to backup the entirety of a memory of the mobile computing device 104 into a unit stored in memory 114 such that if a user wishes to restore the mobile computing device 104, the programmer unit 120 may simply flash the memory of the mobile computing device 104 with the backed up unit.

The programmer unit 120 may additionally be configured to configure the mobile computing device 104 to alert a user of the mobile computing device 104 that the device has been repurposed. In this regard, it may be desirable to alert a user of the repurposing of the device as a repurposed device is physically identical to the original device. This alert may be a simple notification presented to a user of the mobile computing device 104 the first or even every time the device 104 is powered on following repurposing. Additionally or alternatively, the alert may comprise a notification displayed on a display of the mobile computing device 104 periodically or permanently while the device 104 is on. An alert notification may additionally or alternatively be displayed on a device screensaver. For example, if the mobile computing device 104 has been repurposed for use as an English-to-Spanish translation device, a text banner may be displayed stating that the device is an “English-to-Spanish Translator Device.” Accordingly, users of a repurposed mobile computing device 104 may avoid mistaking the device as a device configured to use for its former purpose, such as for use as a cellular telephone.

The programmer unit 120 may further be configured to direct a user to a payment web site to arrange payment for the application(s) programmed into the memory of the device. The payment site may administered by the application provider 106 or by a third party, such as a developer of the individual application(s) programmed into the mobile computing device 104. Accordingly, a user may pay for programmed applications over the internet, such as with a credit card, bank account number, an online payment service (e.g., PayPal™), store points, vouchers, gift certificates, and/or the like. Additionally or alternatively, a user may arrange for a bill to be sent to the user's residence, such as by the user providing his home address or other billing information. In an exemplary embodiment, the user may be provided with a code, such as, for example, an alphanumeric sequence, upon completion of payment for the application(s). The user may then enter the code into the mobile computing device 104 so as to unlock or otherwise enable the application(s) programmed into the mobile computing device 104 so that the user may use the application(s). Accordingly, in such an exemplary embodiment, the programmer unit 120 may be configured to program the mobile computing device 104 so as to block use of an application programmed into a memory of the mobile computing device 104 until a user enters a valid code into the device to unlock the application.

Although a user may be prompted to pay upon each programming of an application into a mobile computing device 104, a user may additionally or alternatively pay a subscription fee prior to or following programming of an application into memory of the mobile computing device 104. In this regard, for example, a user may pay a periodic (e.g., monthly or annual) subscription fee that may entitle a user to download and program applications into a mobile computing device 104. The subscription may allow a user the right to download and program an unlimited number of applications into a mobile computing device 104 over the subscription period. Alternatively, the subscription may limit the user to downloading and programming a finite number of applications over the subscription period. For example, a limited subscription may allow a user to download and program two applications per month. Further, a subscription may allow a user to download and program applications into any mobile computing device 104 owned by the user or may be limited to a specific mobile computing device 104. In another example, a user may prepay for the right to download and program a certain number of applications into a mobile computing device 104 without limit as to the time frame within which the user must download the applications. The user may then receive a number of tokens or credits to a user account with an application provider that may be exchanged for downloading and programming an application into a mobile computing device 104. Accordingly, the programmer unit 120 may be configured to direct a user to a payment website based upon a user's subscription parameters and/or a user's download history. For example, if a user has exceeded the limits of his subscription terms (e.g., downloaded more applications than allowed by subscription terms, expired subscription, or out of download credits), the programmer unit 120 may direct the user to a payment website to arrange for the user to make an additional payment. Additionally or alternatively, the programmer unit 120 may be configured to alert the user prior to downloading and programming an application that the user's subscription terms do not allow for downloading a selected application without further payment.

Although in some example embodiments described above, the programmer unit 120 may be configured to direct a user to a payment website after an application has been downloaded and programmed into a mobile device 104, it will be appreciated that in other embodiments, the programmer unit 120 may be configured to direct a user to a payment website prior to downloading and programming an application into a mobile device 104 such that the user must prepay. Further, it will be appreciated that payment arrangements for an application do not necessarily have to be arranged over a website. Additionally or alternatively, a user may arrange for payment over a telephone, via e-mail, or in person (e.g., in situations where a user brings a mobile computing device 104 into a store for repurposing).

It will be appreciated that the programmer device 102 may be configured to program one or more applications into a memory of the mobile computing device 104 so as to repurpose the device 104 for virtually any practical purpose. Examples include, but are not limited to repurposing for use as a radio (e.g., an FM radio, AM radio, and/or the like), a short-range communications device (e.g., a walkie-talkie), an illumination device (e.g. a flash light), a clock, an alarm clock, a gaming device, a language translation device, an electronic dictionary, a personal digital assistant, a data storage device, a media player (e.g., a music player, video player, and/or the like), a personal navigation device (e.g. a GPS navigation device if the mobile computing device 104 has GPS hardware), digital camera (e.g. using camera hardware included in the mobile computing device 104 with enhanced camera software) and/or the like. In one example use scenario, a mobile computing device 104 may be repurposed as a radio and/or illumination device for distribution to poor workers in developing nations.

Further, exemplary embodiments of the programmer unit 120 provide for the repurposing of mobile computing devices 104 to be executed by virtually any computing device capable of executing and/or remotely accessing the programmer unit 120. Accordingly, an owner of a mobile computing device 104 may download or otherwise install a programmer unit 120 on a home computer and use the home computer to repurpose the mobile computing device 104. Vendors or other shopkeepers may maintain computing devices with an installed programmer unit 120 so as to allow individuals without personal computers to bring their mobile computing devices 104 into a store for repurposing.

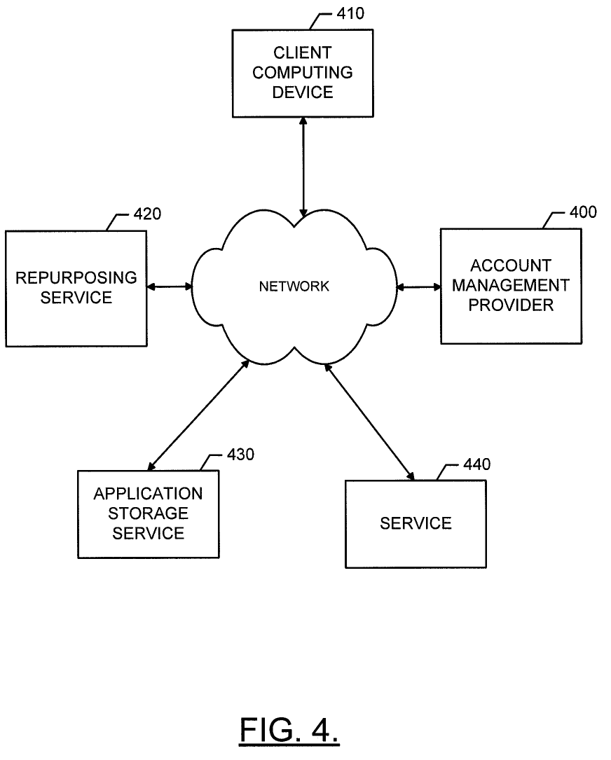

In some embodiments, the programmer unit 120, programmer device 102, and/or the application provider 106 may comprise a system providing a plurality of services to users of computing devices, such as, for example, a mobile computing device 104. In this regard, and referring now to FIG. 4, an embodiment of a system for providing a plurality of services, including device repurposing, to computing devices in accordance with aspects of the present invention is illustrated. The system of FIG. 4 may include an account management provider 400, a client computing device 410, a repurposing service 420, an application storage service 430, and a service provider 440. The account management provider 400, the client computing device 410, the repurposing service 420, the application storage service 430, and the service provider 440 may be interconnected via the illustrated network, which may operate in the same manner as network 108.

The account management provider 400 may comprise any computing device or plurality of computing devices configured to (e.g., through specially configured hardware, such as, an appropriately configured processor, and/or through specially configured software, such as may be executed by a processor) provide a single service sign-on and/or interface to a plurality of services and/or service providers such that a user of a computing device may access a plurality of services through a single integrated account interface provided by the account management provider 400. As used herein, “service” may include data or other content as well as services, such as, for example, e-mail, instant messaging, multi-player gaming, peer-to-peer file transfer, web browsing, social networking, photograph hosting, video hosting, and other multimedia hosting services that may be accessed by and/or supplied to remote computing devices over a network or communications link, such as the network 108. In this regard, repurposing of computing devices may comprise a service. Accordingly, a user of a computing device may be able to access a repurposing service as well as other services through the account management provider 400. Users may register computing devices, such as, for example, a mobile computing device 104, with the account management provider 400 such that the user may access services (e.g., repurposing services) via and/or for the mobile computing device 104 from the account management provider 400. These services may be provided by the repurposing service 420, application storage service 430, and/or service 440 as will be described further below.

The client computing device 410 may be configured to access services through the account management provider 400 and may comprise a programmer device 102 and/or a mobile computing device 104. In this regard, the client computing device 410 may provide an end user interface to the repurposing service 420, account management provider 400, and/or the service provider 440 and accordingly may communicate with the repurposing service 420, account management provider 400, and/or service provider 440 over the network. In embodiments wherein the client computing device 410 is embodied as a programmer device 102, the client computing device 410 may be configured to connect to a mobile computing device 104, such as via a communications link 110 and execute or otherwise embody the programmer unit 120. Alternatively, in embodiments wherein the client computing device 410 is embodied as a mobile computing device 104, the client computing device 410 may be configured to communicate either directly or indirectly, such as via the account management provider 400, with the repurposing service 420 such that the repurposing service 420 may repurpose the client computing device 410.

The repurposing service 420 may comprise one or more of the programmer device 102, application provider 104, and/or the programmer unit 120. In this regard, the repurposing service 420 may be embodied as any computing device or plurality of computing devices configured to provide repurposing services to users of computing devices, such as mobile computing devices, as described above. Accordingly, the repurposing service 420 may comprise and/or otherwise execute the programmer unit 120 such that a user may interface a mobile computing device 104 and/or a client computing device 410 with the repurposing service 420 through the account management provider 400 via the network in order to repurpose the mobile computing device 104. Additionally or alternatively, the repurposing service 400 may be configured to provide the programmer unit 120 to a remote computing device (e.g., the client computing device 410) over the network such that the programmer unit 120 may be installed on the remote computing device so that the remote device constitutes a programmer device 102. The repurposing service 420 may additionally be configured to provide selected applications for repurposing a mobile computing device 104 to the client computing device 410. These applications may be accessed from an application storage service 430, which may be embodied as an application provider 106.

Although only one service provider 440 is shown in FIG. 3, the system may comprise a plurality of service providers 440. In this regard, each service provider 440 represents a service provider, such as, for example, a multimedia service provider, which may be accessed through the account management provider 400.

Accordingly, a user may register or otherwise interface a mobile computing device 104 with the account management provider 400. The account management provider may be configured to direct the user to the repurposing service 420 to ask whether the user wants to repurpose or otherwise add new applications to the mobile computing device 104. The repurposing service 420 may then be configured to either directly analyze or provide a programmer unit 120 to the client computing device 410 configured to analyze the mobile computing device 104 to determine one or more capabilities of the mobile computing device 104 and suggest one or more applications that the mobile computing device 104 is capable of implementing based at least in part upon the determined capabilities. See, e.g., FIG. 3. The repurposing service 420 may be configured to receive, from the client computing device 410, a selection of one or more of the suggested applications. The repurposing service 420 may then be configured to retrieve the selected applications, such as from the application storage service 430 and send the selected applications to the client computing device 410, where the applications may be programmed into a memory of the client computing device 410 (e.g., if the client computing device 410 is embodied as a mobile computing device 104) or may be programmed into a memory of a connected mobile computing device 104 such that the mobile computing device 104 is repurposed. The repurposing service 420 and/or the account management provider 400 may then be configured to direct the user to arrange payment as previously described.

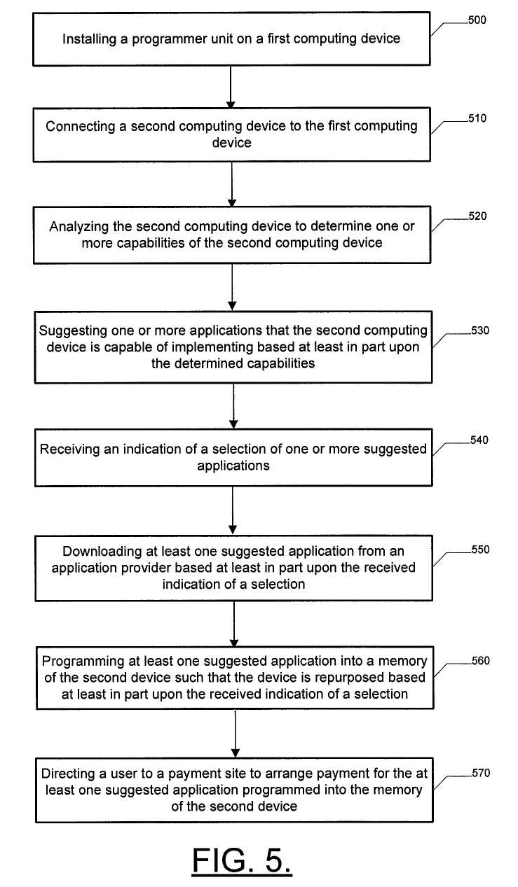

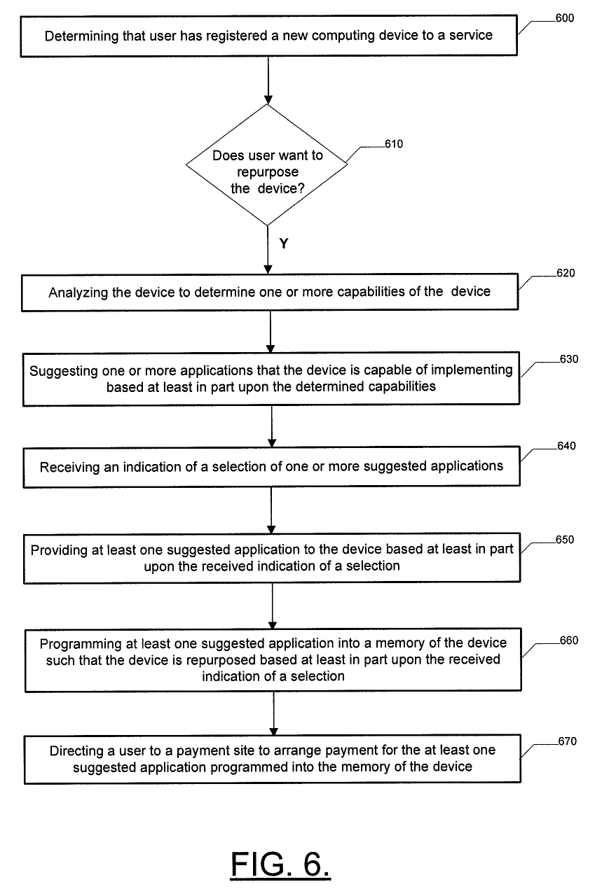

FIGS. 5-6 are flowcharts of a system, method, and computer program product according to an exemplary embodiment of the invention. It will be understood that each block or step of the flowcharts, and combinations of blocks in the flowcharts, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, server, or other computing device and executed by a processor in the computing device. In some embodiments, the computer program instructions which embody the procedures described above may be stored by memory devices of a plurality of computing devices. As will be appreciated, any such computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

In this regard, one exemplary method for repurposing computing devices according to an exemplary embodiment of the present invention is illustrated in FIG. 5. The method may include installing a programmer unit 120 onto a first computing device, such as a programmer device 102, at operation 500. Operation 510 may comprise connecting a second computing device, such as a mobile computing device 104, to the first computing device via a communications link 110. The programmer unit 120 may then analyze the second computing device to determine one or more capabilities of the second computing device at operation 520. Operation 530 may comprise the programmer unit 120 suggesting one or more applications that the second computing device is capable of implementing based at least in part upon the determined capabilities. The programmer unit 120 may then receive an indication of a user selection of one or more suggested applications at operation 540. Operation 550 may comprise the programmer unit 120 downloading at least one suggested application from an application provider 106 based at least in part upon the received indication of a selection. The programmer unit 120 may then program at least one suggested application into a memory of the second device such that the device is repurposed based at least in part upon the received indication of a selection at operation 560. Operation 570 may comprise the programmer unit 120 directing a user to a payment site to arrange payment for the at least one suggested application programmed into the memory of the second device.

FIG. 6 illustrates an exemplary method for repurposing computing devices over a system for providing a plurality of services, including device repurposing, to computing devices according to an exemplary embodiment of the present invention. The method may include an account management provider 400 determining that a user has registered a new computing device, such as, for example, a mobile computing device 104 to a service accessed through the account management provider 400, at operation 600. Operation 610 may comprise the account management provider 400 determining whether the user wishes to repurpose or otherwise install new applications on the newly registered device. If the user selects to repurpose the newly registered device, the repurposing service 420, such as by using or providing a programmer unit 120, may analyze the newly registered device to determine one or more capabilities of the device, at operation 620. Operation 630 may comprise the programmer unit 120 suggesting one or more applications that the newly registered device is capable of implementing based at least in part upon the determined capabilities. One or more of the account management provider 400, repurposing service 420, and programmer unit 120 may then receive an indication of a user selection of one or more suggested applications at operation 640. Operation 650 may comprise the repurposing service 420 providing at least one suggested application to the client computing device 410 based at least in part upon the received indication of a selection. The programmer unit 120 may then program at least one suggested application into a memory of the newly registered device such that the newly registered device is repurposed based at least in part upon the received indication of a selection at operation 660. Operation 670 may comprise the programmer unit 120, account management provider 400, and/or the repurposing service 420 directing a user to a payment site to arrange payment for the at least one suggested application programmed into the memory of the newly registered device. Although, FIG. 6 illustrates a method for repurposing a “newly registered device,” it will be appreciated that the system of FIG. 3 may repurpose a previously registered device as well. In this regard, a user may access the repurposing service 420 via the account management provider 400 at any time so as to repurpose a registered device.

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention may provide several advantages to a user of a computing device, such as a mobile terminal 10. Embodiments of the invention may provide for repurposing of computing devices for a purpose other than that for which the computing device was originally designed and sold. Accordingly, the lifespan of the physical computing device may be extended beyond the period for which the computing device was used for its original purpose. Users may thus benefit from being able to extend the life of previously purchased computing devices by repurposing them for a new purpose. Further, users may save money by not having to buy additional devices to implement functionalities that may be implemented by a repurposed computing device. Consumers in developing countries as well as consumers of lesser means in first world nations may benefit from the availability of low-cost repurposed computing devices. Additionally, several environmental benefits may inure from embodiments of the invention. For example, repurposing computing devices reduces the amount of abandoned computing devices filling landfills. Further, embodiments of the invention allow for repurposing of computing devices to be executed using a home computer and thus gas may be saved that would otherwise be expended physically transporting a computing device to a landfill, recycling center, or other location through which a user would dispose of an old computing device.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
analyzing a connected device to determine one or more capabilities of the device;
suggesting one or more applications that the device is capable of implementing based at least in part upon the determined capabilities; and
programming at least one suggested application into a memory of the device such that the device is repurposed.

2. A method according to claim 1, further comprising:
receiving an indication of a selection of one or more suggested applications; and
wherein programming at least one suggested application comprises programming at least one suggested application based at least in part upon the received indication of a selection.

3. A method according to claim 1, further comprising:
downloading at least one suggested application; and
wherein programming at least one suggested application into a memory of the device comprises erasing the memory of the device and re-flashing the memory with at least one downloaded application.

4. A method according to claim 1, wherein analyzing the connected device comprises analyzing the device to determine one or more of a type of the device, computing resources available on the device, hardware components implemented in the device, software components installed on the device, or firmware components installed on the device.

5. A method according to claim 1, wherein analyzing the connected device further comprises analyzing the device to determine at least one of operability of one or more hardware components implemented in the device, operability of one or more software components installed on the device, or operability of one or more firmware components installed on the device.

6. A method according to claim 5, further comprising providing information about recycling the device if it is determined that one or more components of the device are inoperable such that the device cannot be repurposed.

7. A method according to claim 1, further comprising backing up data stored in the device and a state of the device prior to programming at least one suggested application into the device.

8. A method according to claim 7, further comprising restoring the device to a prior state based at least in part upon one or more of the backed up data or state of the device.

9. A method according to claim 1, further comprising configuring the device to alert a user of the device that the device has been repurposed.

10. A method according to claim 1, wherein programming at least one suggested application into the device such that the device is repurposed further comprises configuring the device such that a cellular phone communications functionality of the device is disabled.

11. A method according to claim 1, wherein programming at least one suggested application comprises programming at least one suggested application into the memory of the device such that the device is repurposed for use as one or more of a radio, short range communications device, illumination device, clock, alarm clock, gaming device, language translation device, electronic dictionary device, personal digital assistant, data storage device, personal navigation device, digital camera, or media player.

12. A method according to claim 1, further comprising directing a user to a payment site to arrange payment for the at least one suggested application programmed into the memory of the device.

13. A computer program product comprising at least one computer-readable storage medium having computer-readable program instructions stored therein, the computer-readable program instructions comprising:
a first program instruction for analyzing a connected device to determine one or more capabilities of the device;
a second program instruction for suggesting one or more applications that the device is capable of implementing based at least in part upon the determined capabilities; and
a third program instruction for programming at least one suggested application into a memory of the device such that the device is repurposed.

14. A computer program product according to claim 13, further comprising:
a fourth program instruction for receiving an indication of a selection of one or more suggested applications; and
wherein the third program instruction includes instructions for programming at least one suggested application into the memory of the device based at least in part upon the received indication of a selection.

15. An apparatus comprising a processor configured to:
analyze a connected device to determine one or more capabilities of the device;
suggest one or more applications that the device is capable of implementing based at least in part upon the determined capabilities; and
program at least one suggested application into a memory of the device such that the device is repurposed.

16. An apparatus according to claim 15, wherein the processor is further configured to:
receive an indication of a selection of one or more suggested applications; and
wherein the processor is configured to program at least one suggested application into the memory of the device by programming at least one suggested application based at least in part upon the received indication of a selection.

17. An apparatus according to claim 15, wherein the processor is further configured to:
download at least one suggested application; and
wherein the processor is configured to program at least one suggested application into the memory of the device by erasing the memory of the device and re-flashing the memory with at least one downloaded application.

18. An apparatus according to claim 15, wherein the processor is configured to analyze the connected device to determine one or more of a type of the device, computing resources available on the device, hardware components implemented in the device, software components installed on the device, or firmware components installed on the device.

19. An apparatus according to claim 15 wherein the processor is configured to analyze the connected device to determine at least one of operability of one or more hardware components implemented in the device, operability of one or more software components installed on the device, or operability of one or more firmware components installed on the device.

20. An apparatus according to claim 19 wherein the processor is further configured to provide information about recycling the device if it is determined that one or more components of the device are inoperable such that the device cannot be repurposed.

21. An apparatus according to claim 15 wherein processor is further configured to back up data stored in the device and a state of the device prior to programming at least one suggested application into the device.

22. An apparatus according to claim 21, wherein the processor is further configured to restore the device to a prior state based at least in part upon one or more of the backed up data or state of the device.

23. An apparatus according to claim 15, wherein the processor is further configured to configure the device to alert a user of the device that the device has been repurposed.

24. An apparatus according to claim 15, wherein the processor is further configured to configure the device such that a cellular phone communications functionality of the device is disabled.

25. An apparatus according to claim 15, wherein the processor is configured to program at least one suggested application by programming at least one suggested application into the memory of the device such that the device is repurposed for use as one or more of a radio, short range communications device, illumination device, clock, alarm clock, gaming device, language translation device, electronic dictionary device, personal digital assistant, data storage device, personal navigation device, digital camera, or media player.

26. An apparatus according to claim 15, wherein the processor is further configured to direct a user to a payment site to arrange payment for the at least one suggested application programmed into the memory of the device.

27. An apparatus comprising:
means for analyzing a connected device to determine one or more capabilities of the device;
means for suggesting one or more applications that the device is capable of implementing based at least in part upon the determined capabilities; and
means for programming at least one suggested application into a memory of the device such that the device is repurposed.
